(19) United States
(12) Patent Application Publication
(10) Pub. No.: US 2026/0206673 A1
(43) Pub. Date: Jul. 23, 2026

(54) INTEGRATED SPROUTER DEVICE

(71) Applicant: WoVa Labs, Inc., Twentynine Palms, CA (US)

(72) Inventors: Douglas Evans, Twentynine Palms, CA (US); Paul Naddaff, Newton, MA (US); Ashley Legg, Düsseldorf (DE)

(21) Appl. No.: 19/570,707

(22) Filed: Mar. 18, 2026

Related U.S. Application Data
(63) Continuation of application No. PCT/US24/45831, filed on Sep. 9, 2024.
(60) Provisional application No. 63/539,259, filed on Sep. 19, 2023.

(51) Int. Cl. A01C 1/02; A01G 31/02; B01D 29/00

(52) U.S. Cl. CPC A01C 1/02; A01G 31/02; B01D 29/0097

(57) ABSTRACT

An integrated sprouter device is proposed. The device may include a container with an open end, a porous filter to fit over the open end of the container, a collar to secure the porous filter flush over a lip of the open end of the container, and a stand. The stand may include an arm that includes a recess or an opening in which the container is placed, and a base, wherein the arm meets the base at an angle.

### INCORPORATION BY REFERENCE TO ANY PRIORITY APPLICATIONS

This is a continuation application of International Patent Application No. PCT/US 24/45831 filed on Sep. 9, 2024, which claims the benefit of U.S. Provisional Application No. 63/539,259, filed Sep. 19, 2023, the entire contents of each of which are hereby incorporated by reference in their entirety.

### BACKGROUND

The disclosure relates generally to devices for sprouting seeds.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that techniques may be embodied or carried out in a manner that achieves or optimizes one advantage or group of advantages as taught herein without necessarily achieving other objects or advantages as may be taught or suggested herein.

In some aspects, an integrated sprouter device is provided. The integrated sprouter device includes a container with an open end, a porous filter to fit over the open end of the container, a collar to secure the porous filter flush over a lip of the open end of the container, and a stand. The stand includes an arm that includes a recess or an opening in which the container is placed, and a base, wherein the arm meets the base at an angle.

In some embodiments, the container is straight-walled. In some embodiments, the pores of the porous filter extend over a lip of the open end of the container. In some embodiments, the pores of the porous filter are flush against the lip of the open end of the container. In some embodiments, the opening includes a through-hole through which the container is to be inserted. In some embodiments, the arm includes a wedge and the container is to rest in the recess of the wedge. In some embodiments, the arm includes a cradle and the container is to rest in the recess of the cradle. In some embodiments, the angle is between 20 and 60 degrees.

Any of the features of an aspect is applicable to all aspects identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects. Any aspect of a method can comprise another aspect of a system. Furthermore, any aspect of a system can be configured to perform a method of another aspect.

### BRIEF DESCRIPTION OF THE DRAWINGS

FIG. 1 is a perspective view illustration of a integrated sprouter device, according to some embodiments.

FIG. 2 is a perspective view illustration of a container, a porous filter, and a collar of the integrated sprouter device, according to some embodiments.

FIG. 3 is a cross-sectional illustration of the integrated sprouter device of FIG. 2, according to some embodiments.

FIG. 4A is a side view illustration of the container, according to some embodiments.

FIG. 4B is a cross-sectional illustration of the container of FIG. 4A, according to some embodiments.

FIGS. 5A-5C are illustrations of the porous filter, according to some embodiments.

FIG. 6 is a perspective view illustration of a stand of the integrated sprouter device, according to some embodiments.

### DETAILED DESCRIPTION

A detailed description of one or more embodiments of the present disclosure is provided below along with accompanying figures that illustrate the principles of the present disclosure. The present disclosure is described in connection with such embodiments, but the present disclosure is not limited to any embodiment. The scope of the present disclosure is limited only by the claims and the present disclosure encompasses numerous alternatives, modifications and equivalents. Numerous specific details are set forth in the following description in order to provide a thorough understanding of the present disclosure. These details are provided for the purpose of example and the present disclosure may be practiced according to the claims without some or all of these specific details. For the purpose of clarity, technical material that is known in the technical fields related to the present disclosure has not been described in detail so that the present disclosure is not unnecessarily obscured.

Seeds require moisture and airflow to successfully sprout. Conventionally, to aid in the sprouting of seeds, water is added to seeds in a container to moisten the seeds. The water is then drained out of the container. However, the process of draining the container may result in seeds inadvertently spilling out and/or residual water being left in the container. The residual water could also foster bacterial growth, which would render the sprouts unsuitable for human consumption.

Embodiments of an integrated sprouter device are described herein. In various embodiments, the integrated sprouter device comprises one or more of the following components: a container, a porous filter, a collar, and a stand. In some embodiments, the container has one opening. For example, seeds and water can be deposited into the container through the opening. In some embodiments, the porous filter can fit over the opening of the container. At least some pores (e.g., slots) of the filter extend over and are flush against the lip of the opening of the container to allow for water to fully drain out of the container. In some embodiments, the collar comprises a ring that fits around the opening of the container and engages/couples with the exterior surface of the container near the opening. In some embodiments, after the filter is placed over the opening of the container, the collar is then placed over the filter and then engaged with the (e.g., threading features of the) exterior surface of the container to thereby lock/clamp the filter in place over the opening of the container. After engaging the collar over with the exterior surface of container near the opening, the opening of the container can be pointed downwards to allow water to drain out of the container through the filter. In various embodiments, the collared end of the filter-covered container is then inserted into a stand which will engage with the collar of the container and hold the container at an angle relative to the plane on which the stand rests. The stand will suspend the filter-covered opening of the container to drain water into a water capture tray such that the container can be fully drained without human intervention and allow the moistened seeds within the container to successfully sprout without residual water that could result in potential, undesirable bacterial growth.

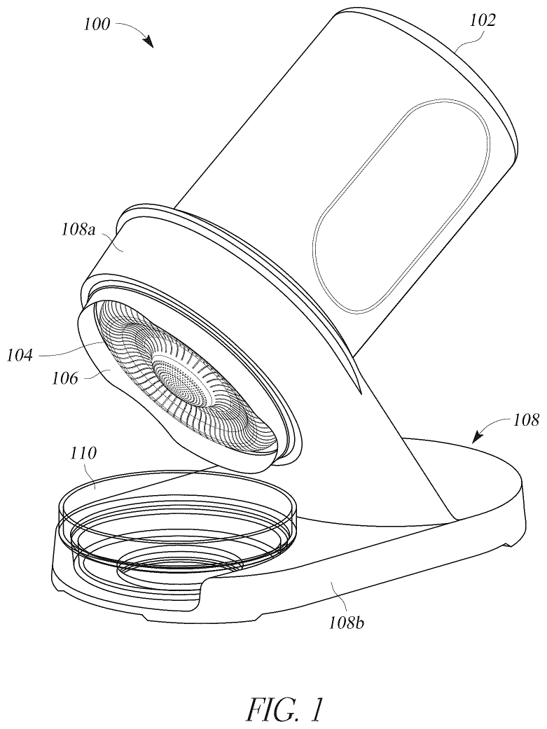

FIG. 1 is a diagram showing an example integrated sprouter device in accordance with some embodiments. As shown in FIG. 1, integrated sprouter device comprises container 102, porous filter 104, collar 106, stand 108, and water capture tray 110. Seeds and water can be added to container 102 while the open end of container 102 is upright. For example, the seeds can be soaked in the water for at least a prescribed length of time before the water is desired to be drained from container 102. When the water is desired to be drained from container 102, porous filter 104 is placed over the open end of container 102 (like an end cap) and then collar 106 is placed over porous filter 104 and then engaged with the engagement features (e.g., threads) located on the exterior surface of container 102. After porous filter 104 and collar 106 are secured at the open end of container 102, that collared end of container 102 is inserted into the angled ring opening of stand 108. The diameter of the ring opening of stand 108 is such that the collared end of container 102 is locked within the ring opening and that container 102 does not fully pass through. Arm 108a of stand 108 that includes the ring opening is at an angle relative to base 108b of stand 108 so as to allow water to drain through porous filter 104 into water capture tray 110. In some embodiments, water capture tray 110 is a removable tray that can be inserted into a cavity or through-hole of a corresponding shape in the base of stand 108 so that it can be cleaned. For example, arm 108b of stand 108 is angled between 20 to 60 degrees. Specifically, the angle can be 35 degrees. One advantage to angling the arm of stand 108 is to allow water to drain from container 102 but also prevent the seeds and eventual sprouts within container 102 from fully covering porous filter 104, which would prevent desired airflow from pass in and out of container 102. For example, if arm 108a were parallel to base 108b of stand 108 (and presuming that base 108b is placed on a plane parallel to the ground), then the seeds and/or sprouts within container 102 could completely cover porous filter 104 and obstruct airflow in and out of container 102, which would be a safety risk. Collar 106 and porous filter 104 are suspended at a distance/airgap above water capture tray 102 such that the used water that drips out of container 102 will not touch and potentially contaminate the seeds and/or sprouts within container 102. In some embodiments, the exterior surface of collar 106 includes protruding features (e.g., ribs) that introduce friction between collar 106 and the internal surface of the ring opening of arm 108a of stand 108. This amount of friction still allows container 102 to rotate within the ring opening of stand 108.

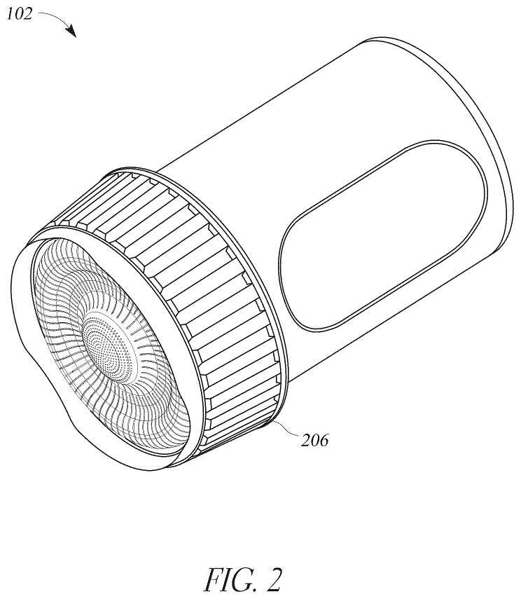

FIG. 2 is a diagram showing an example of a container, a porous filter, and a collar of the integrated sprouter device in accordance with some embodiments. In some embodiments, container 102 and collar 106 of FIG. 1 may be implemented using the example container and collar of FIG. 2. As mentioned above, in some embodiments, collar 206 includes features on its exterior surface that creates friction against the interior surface of the ring opening of the stand (not shown) of the integrated sprouter device. In the example of FIG. 2, collar 206 includes ribs along its exterior surface. The dimensions of the ribs along the exterior surface of collar 206 introduce an amount of friction that secures collar 206 but still allows container 102 to be easily removed from the stand (not shown in FIG. 2) by the user with one hand, without requiring the user's other hand to hold the stand in place. For example, a user may want to rotate the container and collar 206 within the ring opening of the stand to distribute seeds/sprouts within the container and/or to release more water from the container into the water capture tray (not shown). In various embodiments, the collar is made of plastic.

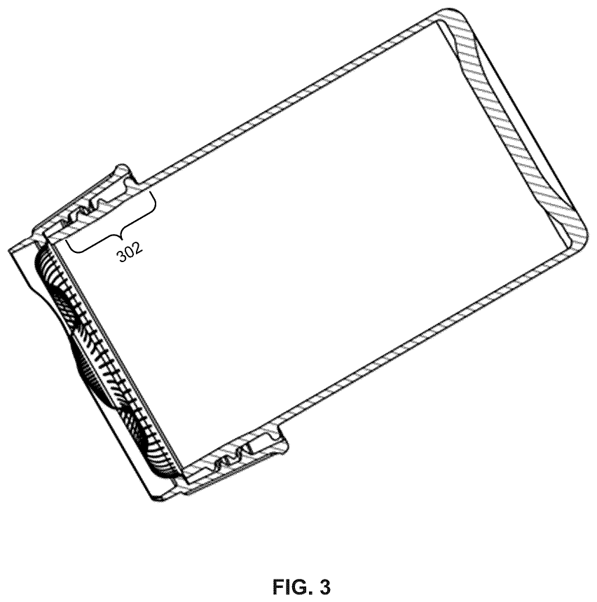

FIG. 3 is a diagram showing a cross-section of a container, a porous filter, and a collar of the integrated sprouter device in accordance with some embodiments. For example, the cross-section shown in FIG. 3 is a cross-section down the center of the combined container, a porous filter, and a collar that is shown in FIG. 2. The cross-sectional view of FIG. 3 shows that the collar is coupled to the container by virtue of being engaged with threading 302 along the exterior surface of the container. In the example of FIG. 3, the interior surface of the collar includes threading features that can be coupled with the threading features along the exterior surface of the container such that the collar can be engaged with and disengaged from the container by twisting in a first direction or an opposite direction.

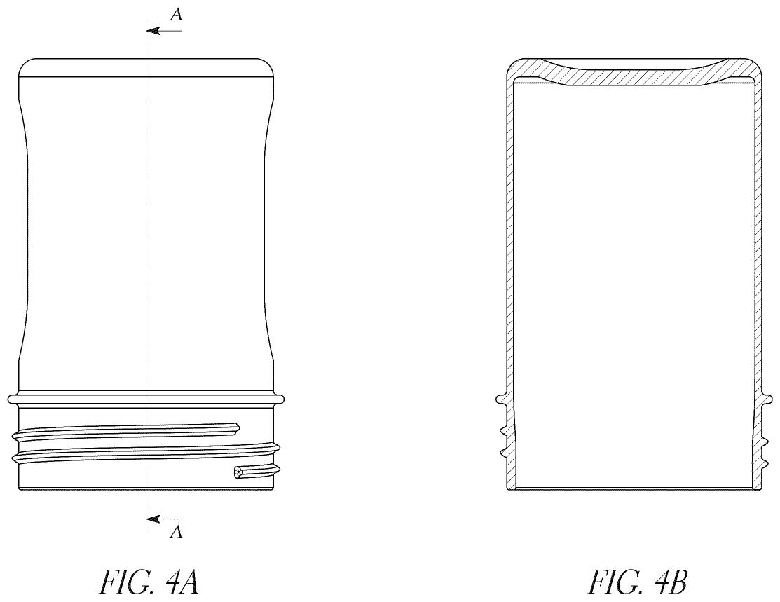

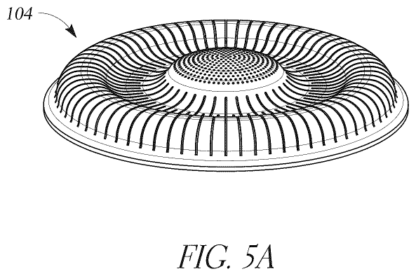

FIGS. 4A and 4B are diagrams two views of the container of the integrated sprouter device in accordance with some embodiments. FIG. 4A shows the exterior surface of the container and highlights that, in some embodiments, the container is substantially a straight cylinder. Put another way, in some embodiments, the container is straight-walled with no narrowed neck near its open end. In contrast, conventional jars are narrower near the mouth. By utilizing a straight-walled design, the water will fully evacuate the container through the filter and there will be no pockets within the container in which water can be trapped. Another advantage of the straight-walled container is that sprouts are able to lay more flat inside the container, which improves air exchange within the mass of sprouts. Yet another advantage of the straight-walled container is that a user is more easily able to reach inside the jar to remove the sprouts at harvest time. While not shown in the example of FIG. 4A, in some embodiments, the container includes large indents that provide grip to a user in holding the container. In various embodiments, the container can be made of glass. In some embodiments, the container is 3 to 9 inches in length and has a diameter of 3 to 6 inches. FIG. 4A also shows another example of the threading features near its open end. FIG. 4B shows a cross-sectional view of the straight-walled container example.

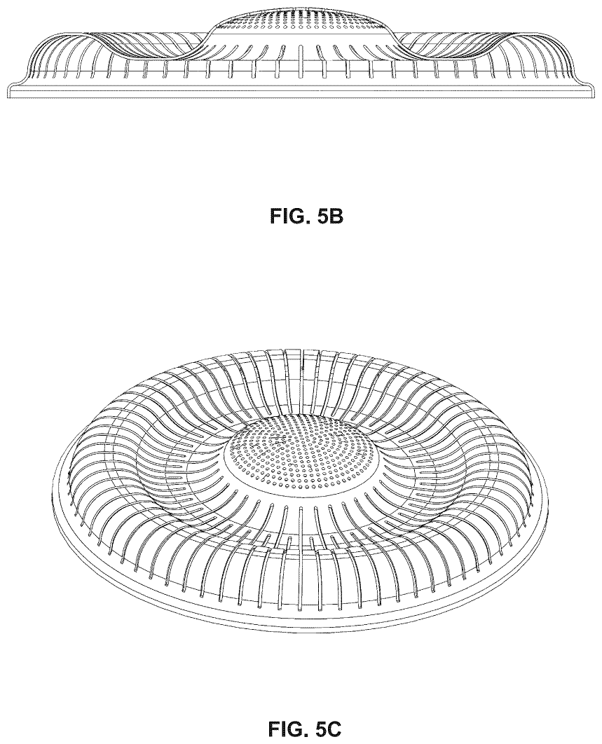

FIG. 5A is a diagram showing an example porous filter in accordance with some embodiments. In some embodiments, porous filter 104 of FIG. 1 may be implemented using the example porous filter of FIG. 5A. In the example of FIG. 5A, the filter is perforated by slots. These slots are precisely positioned to be flush with the edge of the lip/open end of the container (not shown). The combination of the straight-walled container and the filter with slots/pores that are flush with the lip of the open end of the contains allows water to fully drain/evacuate out of the container without obstruction. The collar (not shown) clamps the edge of the porous filter against the lip of the open end of the container in a manner that does not obstruct any water flow. The porous filter is shaped to draw water away from the surface of the filter. In some embodiments, the perforated filter is three-dimensionally formed, not flat. This three-dimensional (contoured) design reduces water from splashing during rinsing. For example, during the sprouting cycle, the user may turn the end of the container that is covered by the porous filter upwards to pour water into the container through the filter to rinse the seeds/sprouts within. The three-dimensional (contoured) design also optimizes airflow in and out of the container by providing a greater surface area. In various embodiments, the porous filter is made of metal (e.g., aluminum, stainless steel). While the example porous filter of FIG. 5A shows a three-dimensional (contoured) design, in some other embodiments, the porous filter may not be contoured. In some embodiments, as shown in FIG. 5B and FIG. 5C, the porous filter may have a flange or lip that extends parallel with the wall of the container. This feature engages with the rim of the jar, effectively centering the filter and preventing it accidentally being knocked off when screwing the “collar” on.

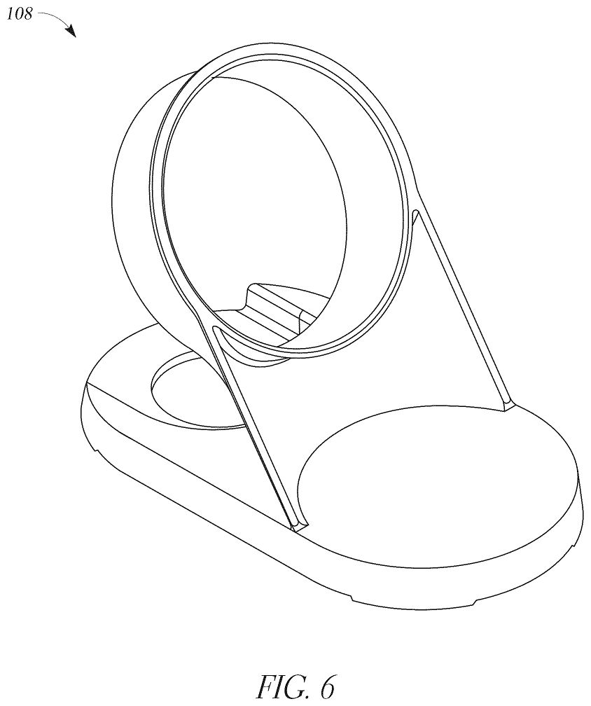

FIG. 6 is a diagram showing an example of a stand of an integrated sprouter device in accordance with some embodiments. In the example of FIG. 6, the stand is shown within an inserted container or a water capture tray in its cavity. As shown in FIG. 6, the base of the stand is wide enough such that the stand does not tip over due to the weight of an inserted container. In one specific example, the stand is 10 inches in depth, 6 inches in width, and 8 inches in height. In some other embodiments, multiple stands could stack together to create tiered units (“multi-sprouter stands”) and such stacked units could have smaller dimensions. While not visible in FIG. 6, the bottom surface of the base of the stand that interfaces with a plane on which the base will rest includes one or more rubber feet that are positioned in such a manner and shape to reduce the ability of the stand to slide forward/backward during use. The feet feature parallel fins can deform against, for example, a countertop surface and increase the friction between the stand and that surface, which will increase the stability of the stand with or within an inserted container.

In some other embodiments, the stand includes more than one arm and where each arm includes an opening through which a respective container can be inserted such that the stand could hold multiple containers. In some other embodiments, the arm comprises a wedge or a cradle that instead of including a circular/ring-shaped opening through which the container can be inserted, includes a half circle (e.g., groove or recess) on which to rest the container.

Although the foregoing embodiments have been described in some detail for purposes of clarity of understanding, the present disclosure is not limited to the details provided. There are many alternative ways of implementing the present disclosure. The disclosed embodiments are illustrative and not restrictive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an integrated sprouter device described herein can be provided separately, or together (e.g., packaged together, or attached together) to form an integrated sprouter device.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An integrated sprouter device, comprising:
a container with an open end;
a porous filter configured to fit over an edge of the open end of the container;
a collar configured to secure the porous filter flush over the edge of the open end of the container; and
a stand comprising:
a base; and
an arm extending from the base at an angle and including a through-hole configured to receive the collar;
wherein the container is substantially a straight-walled container;
wherein the porous filter is perforated by slots; and
wherein the slots are precisely positioned to be flush with the edge of the open end of the container.

2. The integrated sprouter device of claim 1, wherein the slots extend over the edge of the open end of the container.

3. The integrated sprouter device of claim 1, wherein the arm comprises a wedge and wherein the container is configured to rest in the through-hole of the wedge.

4. The integrated sprouter device of claim 1, wherein the arm comprises a cradle and wherein the container is configured to rest in the through-hole of the cradle.

5. The integrated sprouter device of claim 1, wherein the angle is between 20 and 60 degrees.
